(19) United States
(12) Patent Application Publication
(10) Pub. No.: US 2026/0089589 A1
(43) Pub. Date: Mar. 26, 2026

(54) LOSSLESS DELIVERY

(71) Applicant: Nokia Technologies Oy, Espoo (FI)

(72) Inventors: Xiang XU, Beijing (CN); Ling YU, Espoo (FI); Vinh VAN PHAN, Oulu (FI)

(21) Appl. No.: 18/891,840

(22) Filed: Sep. 20, 2024

(51) Int. Cl. H04W 36/02; H04W 76/12

(52) U.S. Cl. CPC H04W 36/023; H04W 76/12

(57) ABSTRACT

Example embodiments of the present disclosure relate to apparatuses, methods, and computer readable storage medium for lossless delivery. In a method, a first apparatus, receives from a second apparatus or a third apparatus, an indication that a communication between the first apparatus and a fourth apparatus is using an indirect communication path via a fifth apparatus; and determine, based on the received indication, whether a data packet is to be removed from a buffer.

### FIELDS

Various example embodiments of the present disclosure generally relate to the field of telecommunication and in particular, to apparatuses, methods, and computer readable storage medium for lossless delivery.

### BACKGROUND

SL based U2N relay in current releases, release-17 and release-18, is a single-hop (SH) U2N relay wherein a remote UE is connected to a single UE-to-Network (U2N) relay UE directly over SL and using the U2N relay UE to connect to a serving network. Lossless delivery is supported in current system, e.g., via Radio Link Control (RLC) Acknowledged Mode (AM). Lossless handover is supported in current system, e.g., refer to “lossless handover”.

### SUMMARY

In a first aspect of the present disclosure, there is provided a first apparatus. The first apparatus includes at least one processor; and at least one memory storing instructions that, when executed by the at least one processor, cause the first apparatus at least to: receive, from a second apparatus or a third apparatus, an indication that a communication between the first apparatus and a fourth apparatus) is using an indirect communication path via a fifth apparatus; and determine, based on the received indication, whether a data packet is to be removed from a buffer.

In a second aspect of the present disclosure, there is provided a second apparatus. The second apparatus includes at least one processor; and at least one memory storing instructions that, when executed by the at least one processor, cause the second apparatus at least to: transmit, to a first apparatus, an indication that a communication between the first apparatus, the second apparatus, and a fourth apparatus is using an indirect communication path via a fifth apparatus.

In a third aspect of the present disclosure, there is provided a third apparatus. The third apparatus includes at least one processor; and at least one memory storing instructions that, when executed by the at least one processor, cause the third apparatus at least to: transmit, to a first apparatus, an indication that a communication between the first apparatus, a second apparatus, and a fourth apparatus is using an indirect communication path via a fifth apparatus.

In a fourth aspect of the present disclosure, there is provided a method. The method includes: receiving, from a second apparatus) or a third apparatus, an indication that a communication between the first apparatus and a fourth apparatus is using an indirect communication path via a fifth apparatus; and determining, based on the received indication, whether a data packet is to be removed from a buffer.

In a fifth aspect of the present disclosure, there is provided a method. The method includes: transmitting, to a first apparatus, an indication that a communication between the first apparatus, the second apparatus, and a fourth apparatus is using an indirect communication path via a fifth apparatus.

In a sixth aspect of the present disclosure, there is provided a method. The method includes: transmitting, to a first apparatus, an indication that a communication between the first apparatus), a second apparatus, and a fourth apparatus is using an indirect communication path via a fifth apparatus.

In a seventh aspect of the present disclosure, there is provided a first apparatus. The first apparatus includes means for receiving, from a second apparatus or a third apparatus, an indication that a communication between the first apparatus and a fourth apparatus is using an indirect communication path via a fifth apparatus; and means for determining, based on the received indication, whether a data packet is to be removed from a buffer.

In an eighth aspect of the present disclosure, there is provided a second apparatus. The second apparatus includes means for transmitting, to a first apparatus, an indication that a communication between the first apparatus, the second apparatus), and a fourth apparatus is using an indirect communication path via a fifth apparatus.

In a ninth aspect of the present disclosure, there is provided a third apparatus. The third apparatus includes means for transmitting, to a first apparatus, an indication that a communication between the first apparatus, a second apparatus, and a fourth apparatus is using an indirect communication path via a fifth apparatus.

In a tenth aspect of the present disclosure, there is provided a computer readable medium. The computer readable medium includes instructions stored thereon for causing an apparatus to perform at least the method according to the fourth aspect.

In an eleventh aspect of the present disclosure, there is provided a computer readable medium. The computer readable medium includes instructions stored thereon for causing an apparatus to perform at least the method according to the fifth aspect.

In a twelfth aspect of the present disclosure, there is provided a computer readable medium. The computer readable medium includes instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure may be implemented;

FIG. 2 illustrates a signaling flow of communication in accordance with some embodiments of the present disclosure;

FIG. 3 illustrates a signaling flow of communication in accordance with some embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a flowchart of a method implemented at a third device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (cNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN), may be based on split architecture. A RAN node, for example, a gNB, includes a Central Unit (CU) and one or more Distributed Unit (DU). A CU may further include a Control Plane (CP), and one or more User Plane (UP). For example, a gNB may include a gNB-CU and one or more gNB-DU(s). A gNB-CU may further include a gNB-CU-CP and one or more gNB-CU-UP(s).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The inter-gNB Distributed Unit (DU) call flow has been proposed. In case of inter-gNB handover (HO), source gNB-DU communicates with source gNB-Central Unit (CU). Target gNB-DU communicates with Target gNB-Central Unit (CU).

The gNB-CU sends a UE CONTEXT MODIFICATION REQUEST message to the source gNB-DU, which includes a generated RRCReconfiguration message and indicates to stop the data transmission for the UE. The source gNB-DU also sends a Downlink Data Delivery Status (DDDS) frame to inform the gNB-CU about the unsuccessfully transmitted downlink data to the UE.

Example behavior of the gNB-CU-UP's behavior upon the reception of the DDDS are discussed as below. The corresponding node (i.e., gNB-DU) shall send the DL DATA DELIVERY STATUS if the Report Polling Flag is set to 1 or when the NR (Packet Data Convergence Protocol) PDCP Protocol Data Unit (PDU) with the indicated DL report NR PDCP PDU sequence number (SN) has been successfully delivered, unless a situation of overload at the corresponding node is encountered. The DL DATA DELIVERY STATUS sent as a response to a specific DL report NR PDCP PDU SN shall be sent only when all PDCP PDU SNs up to this DL report NR PDCP PDU have been successfully delivered in sequence.

The node hosting the NR PDCP entity (i.e., gNB-CU-UP), when receiving the DL DATA DELIVERY STATUS frame: regards the desired buffer size and the data rate above as the amount of data to be sent from the hosting node, and is allowed to remove the buffered NR PDCP PDUs of a RLC AM bearer, according to the feedback of successfully delivered NR PDCP PDUs.

In case of RLC AM, after the highest NR PDCP PDU sequence number successfully delivered in sequence is reported to the node hosting the NR PDCP entity, the corresponding node removes the respective NR PDCP PDUs. For RLC unacknowledged mode (UM), the corresponding node may remove the respective NR PDCP PDUs after transmitting to lower layers.

In normal system (i.e., UE directly connect with gNB-DU), the gNB-CU-UP may frequently use the DDDS (e.g., poll gNB-DU to send DDDS) to determine whether to remove the buffered NR PDCP PDU.

In a Layer-2 UE-to-Network (U2N) Relay system, a Remote UE does not directly connect to the gNB. The Remote UE connects with or communicates with the gNB via a Relay UE. The Remote UE may also connect with or communicate with the gNB via more than one Relay UEs, which is referred as multi-hop indirect communication. The communication between the Remote UE and the gNB is referred to as indirect communication via Relay UE. In has been agreed to adopt Solution-D5 (i.e., Proactive Data forwarding from source gNB to target gNB) to address DL lossless path switch.

However, this may not solve the issue of lossless path switching. The source gNB-DU may send DDDS at any time, for example, gNB-DU may send a DDDS before the source gNB-CU initiates the handover, the source gNB-CU-UP may have already discarded the buffered DL data according to the current specification on gNB-CU-UP behavior upon receiving DDDS from gNB-DU. So, it is too late for the CU-UP knows when the i2x path switching is initiated and the UE has an indirect communication path via U2N relay.

When a Remote UE connects with gNB-CU via a Relay UE, the gNB-CU-UP is unaware of the indirect path, i.e. the gNB-CU-UP does not know the communication with the Remote UE is using an indirect path via a Relay UE. As usual, the gNB-CU-UP may frequently poll the gNB-DU to send DDDS and use the received DDDS to remove the buffered DL PDCP PDUs. Once the gNB-CU-UP polls the DDDS, the gNB-DU shall send the DDDS.

However, in indirect path, the gNB-DU cannot know whether a DL PDCP PDU is successfully received by the Remote UE as the lower layer acknowledgement (e.g., Automatic Repeat Request (ARQ) ACK in radio link control (RLC layer)) may only indicate the successful delivery of the data to the Relay UE. This is different to direct path that the UE directly connects with gNB-DU.

Based on the DDDS, the gNB-CU-UP may incorrectly remove the buffered DL PDCP PDUs that have not been successfully received by the Remote UE. This may cause DL PDU loss in general. In case of inter-gNB path switching, data forwarding from the source gNB to the target gNB will be impacted to cause the DL PDU loss even solution-D5 is applied. Needless to say, it is not possible for lossless data delivery or lossless path switching/handover, since the DL PDUs may already be removed before HO.

An example is given below:
Step 1: gNB-CU-UP has DL data #10, #11, #12, #13 stored in its buffer.
Step 2: gNB-CU-UP sends DL data #10, #11 and #12 to gNB-DU.
Step 3: gNB-DU sends DL data #10 and #11 to Relay UE, and receives RLC ack from Relay UE. gNB-DU considers the DL data #10 and #11 are successful transmitted.
Step 4: gNB-DU sends a DDDS to gNB-CU-UP to indicate DL data #10 and #11 have been successfully transmitted. gNB-CU-UP removes DL data #10 and #11 from its buffer.
Step 5: Relay UE failed to transmit DL Data #10 and #11 to Remote UE due to poor PC5 connection.
Step 6: Source gNB-CU-CP initiates the inter-gNB path switch.
Step 7: Source gNB-CU-UP only forwards DL data #11 and #12 to target gNB-CU-UP.

In this example, the Remote UE failed to receive PDCP #10 and #11, but gNB-CU-UP considers both are successfully transmitted to Remote UE. So, a method is needed to support the lossless delivery before a handover, and further support the lossless handover.

According to the present disclosure, a solution for handover is proposed. In the solution, a first apparatus, receives from a second apparatus or a third apparatus, an indication that a communication between the first apparatus and a fourth apparatus is using indirect path via a fifth apparatus; and determine, based on the received indication, whether a data packet is to be removed from a buffer. In this way, the lossless handover is well supported.

### Example Environment

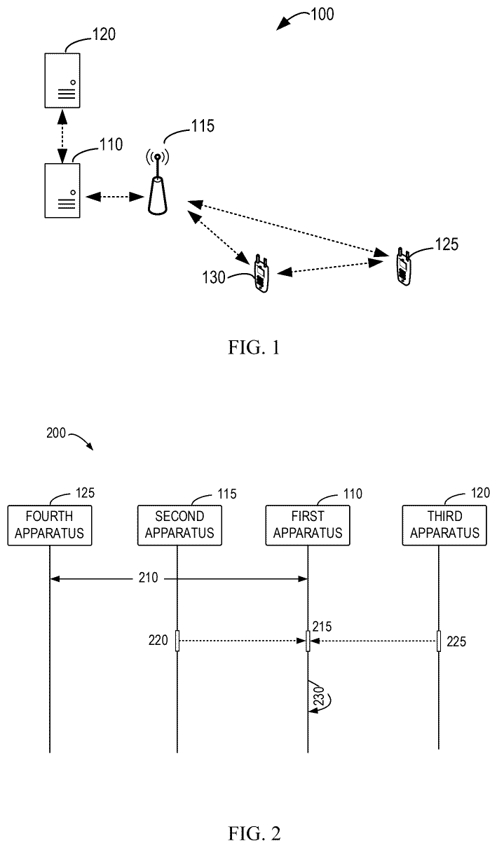

FIG. 1 illustrates an example communication environment 100 in which example embodiments of the present disclosure may be implemented. The communication environment 100 includes a first apparatus 110, a second apparatus 115, a third apparatus 120 and a fourth apparatus 125 and a fifth device 130.

In FIG. 1, the first apparatus 110 may include a user plane of a Central Unit of a network device, the second apparatus 115 may include a distributed unit of the network device, the third apparatus 120 may include a control plane of the Central Unit of the network device, the fourth apparatus 125 may include a remote terminal device, and the fifth apparatus 130 may include a relay terminal device.

Communications in the communication environment 100 may be implemented according to any proper communication protocol(s), including, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

Although features are discussed separately, it should be understood features discussed below may be implemented separately or in any suitable sub-combination. In present disclosure is not limited in this regard.

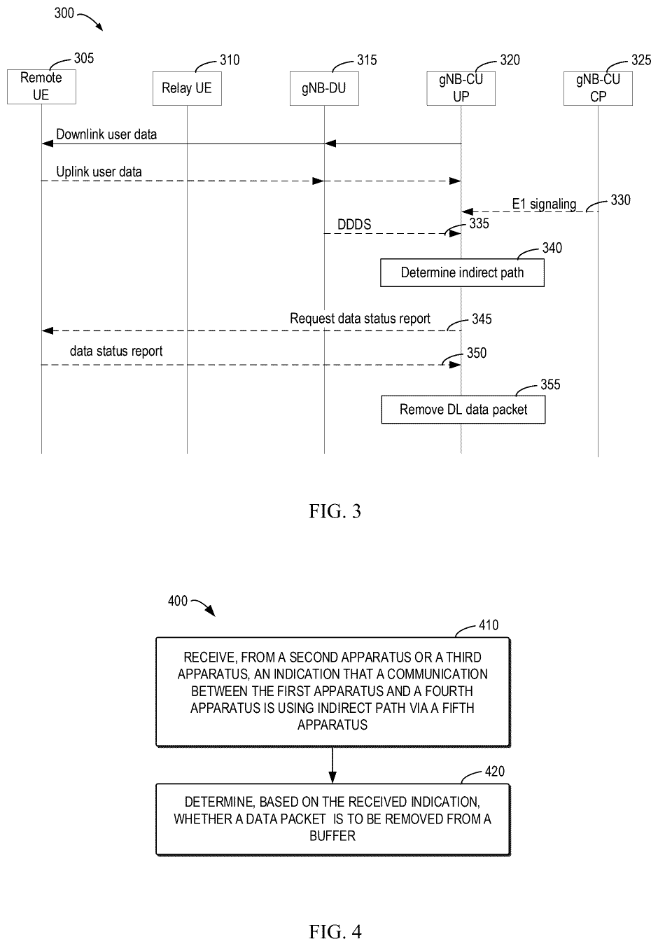

Example processes will be discussed with reference to FIG. 2 and FIG. 3 which illustrates signaling flows 200 and 300 of communication in accordance with some embodiments of the present disclosure. For the purposes of discussion, the signaling flows 200 and 300 will be discussed with reference to FIG. 1, for example, by using the first apparatus 110, the second apparatus 115, the third apparatus 120 and the fourth apparatus 125.

Merely for a better understanding, in the following, the first apparatus 110 may include a user plane of a Central Unit of a network device, the second apparatus 115 may include a distributed unit of the network device, the third apparatus 120 may include a control plane of the Central Unit of the network device, the fourth apparatus 125 may include a remote terminal device, and the fifth apparatus 130 may include a relay terminal device.

Reference is now made to FIG. 2. In FIG. 2, a connection or communication 210 has been established between the first apparatus 110 and the fourth apparatus 125 via the fifth apparatus 130 (not shown in the figure) and the second apparatus 115.

Example operations in perspective of the first apparatus 110 are discussed as below.

In operation, the first apparatus 110 receives 215 from a second apparatus 115 or a third apparatus 120, an indication that a communication between the first apparatus 110 and a fourth apparatus 125 is using indirect path via a fifth apparatus 130. The first apparatus 110 determines 230, based on the received indication, whether a data packet is to be removed from a buffer.

In some embodiments, the first apparatus 110 may based on the received indication, disable use of a downlink data delivery status DDDS received from the second apparatus 115, to remove the data packet from the buffer.

In some embodiments, the indication may be received from the second apparatus 115.

In some embodiments, the first apparatus 110 may receive 215, from the second apparatus 115, a DDDS frame including the indication.

In some embodiments, the first apparatus 110 may receive 215 the indication from the third apparatus 120, during an establishment or modification of a radio bearer associated with the fourth apparatus 125. In another example embodiment, the radio bearer is to be established or modified to use the indirect communication path via a fifth apparatus 130.

In some embodiments, the indication may be associated with a data tunnel between the first apparatus 110 and the second apparatus 115 established or modified for the radio bearer of the fourth apparatus 125. In another example embodiment, the data tunnel convey the uplink data (or downlink data) transmitted from (or transmitted to) the fourth apparatus 125 via a fifth apparatus 130. For example, the data tunnel is used to convey the data of the radio bearer associated with the fourth apparatus 125 using the indirect communication path via a fifth apparatus 130.

In some embodiments, the first apparatus 110 may disable a poll request for a DDDS frame to be transmitted from the second apparatus 115. In another example embodiment, the first apparatus 110 may disable data removal from a buffer based on a DDDS frame received from the second apparatus 115. For example, the downlink data has been transmitted from the first apparatus 110 towards the fourth apparatus 125, but the fourth apparatus 125 may not receive the data yet, for example, the data is buffered in the fifth apparatus 125 and awaiting for transmission to the fourth apparatus 125. The first apparatus 110 should not remove the data from its buffer based on the DDDS received from the second apparatus 115. In other words, the data removal from the buffer based on DDDS is disabled in the first apparatus 110.

In some embodiments, the first apparatus 110 may determine, based on a discard timer associated with the data packet being expired, that the data packet is to be removed from the buffer.

In some embodiments, as shown in FIG. 2, the first apparatus 110 may transmit, to the fourth apparatus 125, a request for a data status report after the indirect communication path is established for the fourth apparatus 125. The first apparatus 110 may receive the data status report from the fourth apparatus 125. The first apparatus 110 may remove 230 the data packet from the buffer based on the received data status report indicating that the data packet is successfully received by the fourth apparatus 125.

In some embodiments, as shown in FIG. 2, the first apparatus 110 may transmit, to the fourth apparatus 125, the request for the data status report based on an amount of data packets in the buffer being equal to or greater than a threshold amount.

In some embodiments, as shown in FIG. 2, the data packet may include a downlink data packet transmitted to the fourth apparatus 125 using the indirect path via the fifth apparatus 130.

Example operations in perspective of the second apparatus 115 are discussed as below.

In some embodiments, the second apparatus 115 may transmit 220, to the first apparatus 110, an indication that a communication between the first apparatus 110, the second apparatus 115, and the fourth apparatus 125 is using indirect path via the fifth apparatus 130.

In some embodiments, the second apparatus 115 may transmit 220, the indication to the first apparatus 110, via a downlink data delivery status DDDS frame.

In some embodiments, as shown in FIG. 2, the indication may be associated with a data tunnel between the first apparatus 110 and the second apparatus 115 for the fourth apparatus 125.

Example operations in perspective of the third apparatus 120 are discussed as below.

In some embodiments, the third apparatus 120 may transmit 225, to the first apparatus 110, an indication that a communication between the first apparatus 110, the second apparatus 115, and the fourth apparatus 125 is using indirect path via the fifth apparatus 130.

In some embodiments, the third apparatus 120 may transmit 225 the indication to the first apparatus 110, during an establishment or modification of a radio bearer associated with the fourth apparatus 125.

In some embodiments, as shown in FIG. 2, the indication may be associated with a data tunnel between the first apparatus 110 and the second apparatus 115 established or modified for the radio bearer of the fourth apparatus 125.

Reference is now made to FIG. 3. Example embodiments of the present disclosure provide a PDCP discard mechanism in the gNB-CU-UP 320 when the F1-U traffic is associated with an indirect path (i.e., Remote UE 305 connects with the gNB via a L2 U2N Relay UE 310, or in case of multi-path with both direct path and indirect path).

In some example embodiments, the gNB-CU-UP 320 may know the UE (i.e., Remote UE 305) is using an indirect path based on an indication received from the gNB-CU-Control Plane (gNB-CU-CP 325) or from gNB-DU 315, then the gNB-CU-UP 320 may take following actions.

In some example embodiments, the gNB-CU-UP 320 does not poll gNB-DU 315 to send 335 DDDS, and/or not use the DDDS to determine the removal of the buffered DL PDCP PDUs. Instead, the gNB-CU-UP 320 may use the discard timer to determine 340 the removal of buffered DL PDCP PDUs or request 345 the UE 305 to send 350 PDCP status report when e.g., the amount of data in the buffer is above the configured threshold.

In some example embodiments, when the gNB-CU-CP 325 may initiate the establishment of a DRB associated with an indirect path for the Remote UE 305, the gNB-CU-CP 325 provides an indication to inform the gNB-CU-UP 320 that a specific F1-U tunnel is associated with indirect path.

For example, when gNB-CU-CP 325 sends 330 the E1 Application protocol (E1AP) UE CONTEXT MODIFICATION REQUEST message to provide the DL F1-U F-TEID to the gNB-CU-UP 320, the CP indicates the F1-U tunnel is related to an indirect path. Based on the indication, the gNB-CU-UP 320 may take different actions as described above.

In some example embodiments, the indication is per F1-U tunnel. This supports the single indirect path, and supports the indirect path of the multi-path via same gNB-DU 315, i.e., a Data Radio Bearer (DRB) is established with one F1-U tunnel for direct path, and another F1-U tunnel for indirect path. Further, the gNB-CU-UP 320 may be allowed to poll/use DDDS for the direct path.

Alternatively, in some example embodiments, when the gNB-DU 315 send 335 the DDDS, the DDDS may have a new indication indicating the F1-U tunnel is associated with an indirect path.

In some example embodiments, the request may be either via PDCP C-PDU or via RRC signaling. In case of the request is via RRC signaling, the gNB-CU-UP 320 may indicate the need of requesting 345 PDCP status report to gNB-CU-CP 325 via E1AP. This is applicable when the Remote UE 305 have a single indirect path, or multi-path with at least one indirect path.

In some example embodiments, the gNB-CU-UP 320 may receive the indirect path indication from the gNB-CU-CP 325.

In some example embodiments, when the gNB-CU-CP 325 initiates the establishment of a DRB associated with an indirect path for the Remote UE 305, the gNB-CU-CP 325 may provide an indication to inform the gNB-CU-UP 320 that a specific F1-U tunnel is associated with indirect path. As one example, when gNB-CU-CP 325 sends 330 the E1AP UE CONTEXT MODIFICATION REQUEST message to provide the DL F1-UF-Tunnel End Point identifier (TEID) to the gNB-CU-UP 320, the CP indicates the F1-U tunnel is related to an indirect path. Based on the indication, the gNB-CU-UP 320 may take different actions as described above.

In some example embodiments, the indication may be per F1-U tunnel. This supports the single indirect path, and supports the indirect path of the multi-path via same gNB-DU 315, i.e., a DRB is established with one F1-U tunnel for direct path, and another F1-U tunnel for indirect path. The gNB-CU-UP 320 is still allowed to poll/use DDDS for the direct path.

Below table 1 and table 2 illustrates example information elements (IEs)/fields for UP parameters, where this IE provides information related to a DRB configured in the gNB-CU-UP 320.

TABLE 1

| | | | IE type and | | | Assigned |
|---|---|---|---|---|---|---|
| IE/Group Name | Presence | Range | reference | Semantics description | Criticality | Criticality |
| UP Parameters | | 1 | | | — | — |
| List | | | | | | |
| >UP Parameters | | 1 . . . | | | — | — |
| Item | | <maxnoofUPParameters> | | | | |
| >>UP Transport | M | | suitable type | | — | — |
| Layer Information | | | | | | |
| >>Cell Group ID | M | | INTEGER | This IE corresponds to | — | — |
| | | | (0 . . . | information provided in the | | |
| | | | 3, . . . ) | CellGroupId IE in TS 38.331 | | |
| | | | | [10] (0 = MCG, 1 = SCG). In | | |
| | | | | this version of the | | |
| | | | | specification, values “2” | | |
| | | | | and “3” are not used. | | |
| >>QoS Mapping | O | | suitable type | This IE is only used for IAB. | YES | reject |
| Information | | | | | | |
| >>Indirect Path | O | | ENUMERATED(true, | This IE is only used for | YES | ignore |
| indication | | | . . . ) | L2 U2N Remote UE | | |

TABLE 2

| Range bound | Explanation |
|---|---|
| maxnoofUPParameters | Maximum no. of UP parameters |
| | (e.g., GTP tunnels) for a DRB. |
| | Value is 8 |

In some example embodiments, the gNB-CU-UP 320 receives the indirect path indication from the gNB-DU 315.

In some example embodiments, the gNB-DU 315 knows whether a F1-U tunnel is associated with indirect path. The gNB-CU-UP 320 may poll the DDDS as usual. When the gNB-DU 315 sends 335 the DDDS, the DDDS may have a new indication indicating the F1-U tunnel is associated with an indirect path. Based on the indication, the gNB-CU-UP 320 may take different actions as described above.

In some example embodiments, a new cause value indicating indirect path may be introduced. Alternatively, in some example embodiments, a new IE, a new SL DDDS frame and other new information may be introduced/indicates.

In some example embodiments, for DL DATA DELIVERY STATUS (PDU Type 1), this frame format is defined to transfer feedback to allow the receiving node (i.e., the node that hosts the PDCP entity) to control the downlink user data flow via the sending node (i.e., the corresponding node).

The following shows the respective DL DATA DELIVERY STATUS frame. Specifically, below table 3 shows an example of how a frame is structured when all optional IEs (i.e., those whose presence is indicated by an associated flag) are present.

TABLE 3

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=1) | | | | Highest | Highest | Final Frame | Lost | 1 |
| | | | | Transmitted | Delivered | Ind. | Packet | |
| | | | | NR PDCP | NR PDCP | | Report | |
| | | | | SN Ind | SN Ind | | | |
| Spare | Feedback | NR-U | Delivered | Data rate | Retransmitted | Delivered | Cause | 1 |
| | Delay | SN | NR PDCP | Ind. | NR PDCP | Retransmitted | Report | |
| | Ind. | Ind. | SN Range | | SN Ind | NR PDCP | | |
| | | | Ind | | | SN Ind | | |

| | |
|---|---|
| Desired buffer size for the data radio bearer | 4 |
| Desired Data Rate | 0 or 4 |

In some example embodiments, the absence of such an IE changes the position of all subsequent IEs on octet level.

In some example embodiments, all the IEs defined in the above table 3 may be also applicable to E-UTRA PDCP unless specified otherwise. With this understanding, each instance of NR PDCP may be replaced by E-UTRA PDCP.

In some example embodiments, the cause is defined as below.
Description: This parameter indicates specific events reported by the corresponding node. This information element is not applicable to E-UTRA PDCP.
Value range: {0=UNKNOWN, 1=RADIO LINK OUTAGE, 2=RADIO LINK RESUME, 3=UL RADIO LINK OUTAGE, 4=DL RADIO LINK OUTAGE, 5=UL RADIO LINK RESUME, 6=DL RADIO LINK RESUME, 7=INDIRECT PATH, 8-228=reserved for future value extensions, 229-255=reserved for test purposes}
Field length: 1 octet.

In some example embodiments, a PDCP status report may be triggered when at least one of the following:
upper layer requests a PDCP entity re-establishment;
upper layer requests a PDCP data recovery;
upper layer requests an uplink data switching;
upper layer reconfigures the PDCP entity to release DAPS and daps-SourceRelease is configured i.

The above example processes may be used to support lossless delivery (and further lossless handover) in a L2 U2N Relay system, and it may be implemented in the gNB-DU 315, gNB-CU-CP 325 and gNB-CU-UP 320.

### Example Methods

FIG. 4 shows a flowchart of an example method 400 implemented at a first apparatus in accordance with some example embodiments of the present disclosure. For the purpose of discussion, the method 400 will be described from the perspective of the first apparatus 110 in FIG. 1, and further be described by referring to FIG. 2 and FIG. 3.

At block 410, the first apparatus receives, from a second apparatus or a third apparatus, an indication that a communication between the first apparatus and a fourth apparatus is using indirect path via a fifth apparatus.

At block 420, the first apparatus determines, based on the received indication, whether a data packet is to be removed from a buffer.

In some example embodiments, based on the received indication, the first apparatus may disable use of a downlink data delivery status (DDDS) received from the second apparatus, to remove the data packet from the buffer.

In some example embodiments, the indication is received from the second apparatus.

In some example embodiments, the first apparatus may receive, from the second apparatus, a DDDS frame including the indication.

In some example embodiments, the first apparatus may receive the indication from the third apparatus, during an establishment or modification of a radio bearer associated with the fourth apparatus, using the communication path via the fifth apparatus.

In some example embodiments, the indication is associated with a data tunnel established between the first apparatus and the second apparatus for the radio bearer of the fourth apparatus.

In some example embodiments, the first apparatus may disable a poll request to prevent a further DDDS frame from being transmitted by the second apparatus.

In some example embodiments, the first apparatus may determine that the data packet is to be removed from the buffer, when a discard timer associated with the data packet has expired.

In some example embodiments, the first apparatus transmits, to the fourth apparatus, a request for a data status report after the indirect communication path via the fifth apparatus has been established for the fourth apparatus; the first apparatus may receive (350) the data status report from the fourth apparatus; and the first apparatus may remove the data packet from the buffer, based on the received data status report indicating that the data packet is successfully received by the fourth apparatus.

In some example embodiments, the first apparatus may transmit, the request for the data status report to the fourth apparatus, based on an amount of data packets in the buffer being equal to or greater than a threshold amount.

In some example embodiments, the data packet includes a downlink data packet transmitted to the fourth apparatus using the indirect path via the fifth apparatus.

In some example embodiments, the first apparatus includes a user plane of a Central Unit of a network device, the second apparatus includes a distributed unit of the network device, the third apparatus includes a control plane of the Central Unit of the network device, the fourth apparatus includes a remote terminal device, and the fifth apparatus includes a relay terminal device.

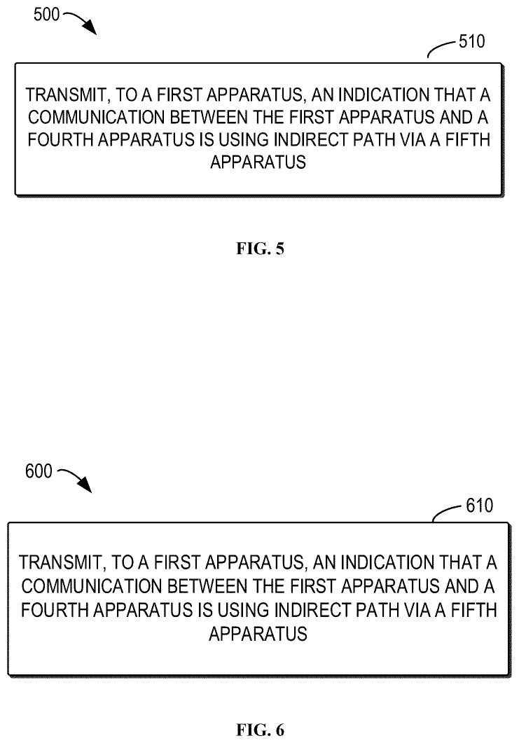

FIG. 5 shows a flowchart of an example method 500 implemented at a second device in accordance with some example embodiments of the present disclosure. For the purpose of discussion, the method 500 will be described from the perspective of the second apparatus 120 in FIG. 1, and further be described by referring to FIG. 2 and FIG. 3.

At block 510, the second apparatus transmits, to a first apparatus, an indication that a communication between the first apparatus and a fourth apparatus is using indirect path via a fifth apparatus.

In some example embodiments, the second apparatus transmits, the indication to the first apparatus, via a downlink data delivery status (DDDS) frame.

In some example embodiments, the indication is associated with a data tunnel between the first apparatus and the second apparatus for the fourth apparatus.

FIG. 6 shows a flowchart of an example method 600 implemented at a third apparatus in accordance with some example embodiments of the present disclosure. For the purpose of discussion, the method 600 will be described from the perspective of the third apparatus 130 in FIG. 1, and further be described by referring to FIG. 2 and FIG. 3.

At block 610, the third apparatus transmits, to a first apparatus, an indication that a communication between the first apparatus and a fourth apparatus is using indirect path via a fifth apparatus.

In some example embodiments, third apparatus may transmit the indication to the first apparatus, during an establishment or modification of a radio bearer associated with the fourth apparatus, using the indirect communication path via the fifth apparatus.

In some example embodiments, the indication is associated with a data tunnel between the first apparatus and the second apparatus established or modified for the radio bearer of the fourth apparatus.

### Example Apparatus, Device and Medium

In some example embodiments, a first apparatus capable of performing any of the method 400 (for example, the first apparatus 110 in FIG. 1) may include means for performing the respective operations of the method 400. The means may be implemented in any suitable form. For example, the means may be implemented in a circuitry or software module. The first apparatus may be implemented as or included in the first apparatus 110 in FIG. 1.

In some example embodiments, the first apparatus includes means for receiving, from a second apparatus or a third apparatus, an indication that a communication between the first apparatus and a fourth apparatus is using an indirect communication path via a fifth apparatus; and means for determining, based on the received indication, whether a data packet is to be removed from a buffer.

In some example embodiments, the first apparatus further includes means for performing other operations in some example embodiments of the method 400 or the first apparatus 110. In some example embodiments, the means includes at least one processor; and at least one memory storing instructions that, when executed by the at least one processor, cause the performance of the first apparatus.

In some example embodiments, a second apparatus capable of performing any of the method 500 (for example, the second device 115 in FIG. 1 may include means for performing the respective operations of the method 500. The means may be implemented in any suitable form. For example, the means may be implemented in a circuitry or software module. The second apparatus may be implemented as or included in the second apparatus 120 in FIG. 1.

In some example embodiments, the second apparatus includes means for transmitting, to a first apparatus, an indication that a communication between the first apparatus, the second apparatus, and a fourth apparatus is using an indirect communication path via a fifth apparatus.

In some example embodiments, the second apparatus further includes means for performing other operations in some example embodiments of the method 500 or the second apparatus 115. In some example embodiments, the means includes at least one processor; and at least one memory storing instructions that, when executed by the at least one processor, cause the performance of the second apparatus.

In some example embodiments, a third apparatus capable of performing any of the method 600 (for example, the third apparatus 120 in FIG. 1 may include means for performing the respective operations of the method 600. The means may be implemented in any suitable form. For example, the means may be implemented in a circuitry or software module. The third apparatus may be implemented as or included in the third apparatus 120 in FIG. 1.

In some example embodiments, the third apparatus includes means for transmitting, to a first apparatus, an indication that a communication between the first apparatus, a second apparatus, and a fourth apparatus is using an indirect communication path via a fifth apparatus.

In some example embodiments, the third apparatus further includes means for performing other operations in some example embodiments of the method 600 or the third apparatus 120. In some example embodiments, the means includes at least one processor; and at least one memory storing instructions that, when executed by the at least one processor, cause the performance of the third apparatus.

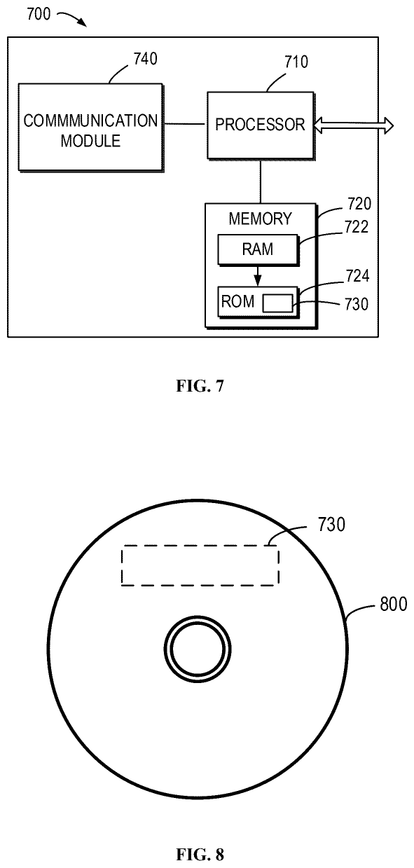

FIG. 7 is a simplified block diagram of a device 700 that is suitable for implementing example embodiments of the present disclosure. The device 700 may be provided to implement a communication device, for example, the first apparatus 110, the second apparatus 115, the third apparatus 120 and the fourth apparatus 125 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
receive, from a second apparatus or a third apparatus, an indication that a communication between the first apparatus and a fourth apparatus is using an indirect communication path via a fifth apparatus; and
determine, based on the received indication, whether a data packet is to be removed from a buffer.

2. The first apparatus of claim 1, wherein the at least one memory and the at least one processor cause the first apparatus to:
based on the received indication, disable use of a downlink data delivery status (DDDS) received from the second apparatus, to remove the data packet from the buffer.

3. The first apparatus of claim 1, wherein the indication is received from the second apparatus.

4. The first apparatus of claim 3, wherein the at least one memory and the at least one processor cause the first apparatus to:
receive, from the second apparatus, a DDDS frame including the indication.

5. The first apparatus of claim 1, wherein the at least one memory and the at least one processor cause the first apparatus to:
receive the indication from the third apparatus, during an establishment or modification of a radio bearer associated with the fourth apparatus, using the indirect communication path via the fifth apparatus.

6. The first apparatus of claim 1, wherein the indication is associated with a data tunnel established between the first apparatus and the second apparatus for the radio bearer of the fourth apparatus.

7. The first apparatus of claim 1, wherein the at least one memory and the at least one processor cause the first apparatus to:
disable a poll request to prevent a further DDDS frame from being transmitted by the second apparatus.

8. The first apparatus of claim 1, wherein the at least one memory and the at least one processor cause the first apparatus to:
determine that the data packet is to be removed from the buffer, when a discard timer associated with the data packet has expired.

9. The first apparatus of claim 1, wherein the at least one memory and the at least one processor cause the first apparatus to:
transmit, to the fourth apparatus, a request for a data status report after the indirect communication path via the fifth apparatus has been established for the fourth apparatus;
receive the data status report from the fourth apparatus; and
remove the data packet from the buffer, based on the received data status report indicating that the data packet is successfully received by the fourth apparatus.

10. The first apparatus of claim 9, wherein the at least one memory and the at least one processor cause the first apparatus to:
transmit, the request for the data status report to the fourth apparatus, based on an amount of data packets in the buffer being equal to or greater than a threshold amount.

11. The first apparatus of claim 1, wherein the data packet includes a downlink data packet transmitted to the fourth apparatus using the indirect communication path via the fifth apparatus.

12. The first apparatus of claim 1, wherein the first apparatus includes a user plane of a central unit (CU) of a network device, the second apparatus includes a distributed unit (DU) of the network device, the third apparatus includes a control plane of the central unit of the network device, the fourth apparatus includes a remote terminal device, and the fifth apparatus includes a relay terminal device.

13. A second apparatus comprising:
at least one processor; and
at least one memory storing instructions that, when executed by the at least one processor, cause the second apparatus at least to:
transmit, to a first apparatus, an indication that a communication between the first apparatus and a fourth apparatus is using an indirect communication path via a fifth apparatus; and
transmit, the indication to the first apparatus, via a downlink data delivery status (DDDS) frame.

14. The second apparatus of claim 13, wherein the indication is associated with a data tunnel between the first apparatus and the second apparatus for the fourth apparatus.

15. A third apparatus comprising:
at least one processor; and
at least one memory storing instructions that, when executed by the at least one processor, cause the third apparatus at least to:
transmit, to a first apparatus, an indication that a communication between the first apparatus and a fourth apparatus is using an indirect communication path via a fifth apparatus; and
transmit the indication to the first apparatus, during an establishment or modification of a radio bearer associated with the fourth apparatus, using the indirect communication path via the fifth apparatus.

16. The third apparatus of claim 15, wherein the indication is associated with a data tunnel between the first apparatus and the second apparatus established or modified for the radio bearer of the fourth apparatus.
